(19) United States
(12) Patent Application Publication
(10) Pub. No.: US 2026/0290278 A1
(43) Pub. Date: Sep. 24, 2026

(54) DATA DRIVING CIRCUIT AND METHOD FOR OPERATING THE SAME

(71) Applicant: Samsung Electronics Co., Ltd., Suwon-si (KR)

(72) Inventors: Ha Jun LEE, Suwon-si (KR); Jae Wook KWON, Suwon-si (KR)

(73) Assignee: Samsung Electronics Co., Ltd., Suwon-si (KR)

(21) Appl. No.: 19/452,597

(22) Filed: Jan. 19, 2026

(30) Foreign Application Priority Data
Mar. 18, 2025 (KR) 10-2025-0034541
Sep. 26, 2025 (KR) 10-2025-0140244

(51) Int. Cl. G09G 5/00

(52) U.S. Cl. CPC G09G 5/003; G09G 2310/0264; G09G 2330/02

(57) ABSTRACT

A data driving circuit comprises a first analog front-end (AFE) circuit configured to sense a first characteristic voltage from a first channel line connected to a first pixel through a first sensing line while a first channel switch is in a turn-on state, and sense a second characteristic voltage from a second channel line connected to a second pixel through the first sensing line while a second channel switch is in a turn-on state, and an ADC configured to convert an output signal received from the first AFE circuit into a digital compensation signal. The first AFE circuit includes a sampling capacitor storing at least a portion of a sensed characteristic voltage, a sampling switch providing the sensed characteristic voltage to the sampling capacitor, and a first reset switch connected between the first sensing line and a first compensation voltage, and operating based on a first reset signal.

### CROSS-REFERENCE TO RELATED APPLICATIONS

This U.S. non-provisional application claims priority under 35 U.S.C. § 119 from Korean Patent Application No. 10-2025-0034541 filed on Mar. 18, 2025, and Application No. 10-2025-0140244 filed on Sep. 26, 2025, in the Korean Intellectual Property Office, the entire contents of both these applications are incorporated herein by reference.

### BACKGROUND

Some example embodiments relate to a data driving circuit and/or a method for operating the same.

Some display devices include organic light emitting diodes (hereinafter, referred to as “OLEDs”) that emit light, and have relatively faster response speed, higher light emitting efficiency, higher luminance, and/or larger viewing angle.

An organic light emitting display device including an organic light emitting diode includes pixels, each of which includes an OLED and a driving Thin Film Transistor (TFT), arranged in a matrix form, and adjusts luminance of an image implemented in a pixel in accordance with gradation of video data. The driving TFT controls a driving current flowing to the OLED in accordance with a voltage applied between gate and source electrodes of the TFT. The amount of light emitted by the OLED is determined depending on the driving current, and luminance of the image is determined depending on the amount of light emitted by the OLED.

When the driving TFT operates in a saturation region, a pixel current flowing between a drain and a source of the driving TFT varies depending on driving characteristics of the driving TFT, such as a threshold voltage and electron mobility. However, a deviation in the driving characteristics of the driving TFT occur between pixels due to various causes, such as process characteristics and time-varying characteristics. Accordingly, even though the same data voltage is applied to pixels with different driving characteristics of the TFT, a luminance variation occurs for each pixel. Therefore, it is challenging to implement an image of desired quality without compensating for such characteristic variation.

In order to sense the driving characteristics of the driving TFT, a compensation method for sensing a voltage value corresponding to the current flowing in the driving TFT is utilized. However, a voltage offset occurs in a sensing value during a sensing process due to various causes and it is challenging to obtain a relatively accurate sensing value due to the voltage offset.

### SUMMARY

Some example embodiments of the present disclosure provide a gate driving circuit that senses driving characteristics of a pixel with relatively improved accuracy.

Some example embodiments of the present disclosure provide a method for operating a gate driving circuit that senses driving characteristics of a pixel with relatively improved accuracy.

The present disclosure are not limited to the description herein and may be modified by those skilled in the art without departing from the spirit and scope of the present disclosure.

According to some example embodiments of present disclosure, a data driving circuit comprises a first analog front-end (AFE) circuit configured to sense a first characteristic voltage from a first channel line connected to a first pixel through a first sensing line while a first channel switch is in a turn-on state, and configured to sense a second characteristic voltage from a second channel line connected to a second pixel through the first sensing line while a second channel switch is in a turn-on state; and an analog-to-digital converter configured to convert an output signal received from the first AFE circuit into a digital compensation signal. The first AFE circuit includes a sampling capacitor configured to store at least a portion of a sensed characteristic voltage, a sampling switch configured to selectively provide the sensed characteristic voltage to the sampling capacitor, and a first reset switch having a first end connected to the first sensing line and a second end configured to receive a first compensation voltage, and the first reset switch configured to operate in accordance with a first reset signal. The first reset switch is configured to selectively provide the first compensation voltage to the first sensing line in response to the first reset signal turning on the first reset switch, the first reset switch is configured to turn on before the second channel switch is turned on, and the second channel switch is configured to turn on after the first channel switch is turned off.

According to some example embodiments of present disclosure, a method for operating a data driving circuit including a first analog front-end (AFE) circuit comprises sensing a first characteristic voltage from a first channel line connected to a first pixel through a first sensing line while a first channel switch is in a turn-on state; turning on a first reset switch in response to a first reset signal to provide a first compensation voltage to the first sensing line, the first reset switch being turned on before a second channel switch is turned on, and the second channel switch being turned on after the first channel switch is turned off; and sensing a second characteristic voltage from a second channel line connected to a second pixel through the first sensing line while the second channel switch is in a turn-on state.

According to some example embodiments of present disclosure, a data driving circuit comprises a first analog front-end (AFE) circuit configured to sense a characteristic voltage of a plurality of pixels through a sensing line and output an output signal; and an analog-to-digital converter configured to receive the output signal, perform analog-digital conversion on the output signal, and output a digital compensation signal based on the analog-digital conversion performed on the output signal. The first AFE circuit includes a sampling capacitor configured to store at least a portion of a sensed characteristic voltage, a sampling switch connected between the sensing line and the sampling capacitor, and configured to selectively provide the sensed characteristic voltage to the sampling capacitor, a first reset switch having a first end connected to the sensing line and a second end configured to receive a first compensation voltage, a second reset switch having a first end connected to a node connecting the sensing line with the sampling capacitor and a second end configured to receive a second compensation voltage, and an output switch configured to selectively connect the sampling capacitor to the analog-to-digital converter and selectively provide the output signal to the analog-to-digital converter.

### BRIEF DESCRIPTION OF THE DRAWINGS

FIG. 1 is a block diagram illustrating a display system that includes a display device.

FIG. 2 is a block diagram illustrating a display device that includes a display driving circuit.

FIG. 3 is a circuit diagram illustrating a pixel of a display panel.

FIG. 4 is a circuit diagram illustrating a 2:1 MUX sensing method that performs 2-channel sensing with one analog front-end (AFE) circuit.

FIG. 5 is a circuit diagram illustrating an analog front-end (AFE) circuit.

FIG. 6 is a circuit diagram illustrating a 4:1 MUX sensing method that performs 4-channel sensing with one analog front-end (AFE) circuit.

FIG. 7 is a timing diagram illustrating a method of operating an analog front-end (AFE) circuit.

FIG. 8 is a circuit diagram illustrating an analog front-end (AFE) circuit.

FIG. 9 is a timing diagram illustrating a method of operating an analog front-end (AFE) circuit.

FIG. 10A is a timing diagram illustrating a method of operating an analog front-end (AFE) circuit.

FIG. 10B is a timing diagram illustrating a method of operating an analog front-end (AFE) circuit.

FIG. 11 is a circuit diagram illustrating a coupling effect between an AFE circuit performing 4:1 MUX sensing and an AFE circuit performing 2:1 MUX sensing, wherein these AFE circuits are adjacent to each other.

FIG. 12 is a circuit diagram illustrating a coupling effect between an AFE circuit performing 4:1 MUX sensing and an AFE circuit adjacent thereto and in a disabled state.

FIG. 13 is a circuit diagram illustrating an analog front-end (AFE) circuit.

FIG. 14 is a timing diagram illustrating a method of operating an analog front-end (AFE) circuit.

### DETAILED DESCRIPTION

Hereinafter, example embodiments of the present disclosure will be described with reference to the accompanying drawings.

As used herein, the term “and/or” includes any and all combinations of one or more of the associated listed items. Expressions such as “at least one of,” when preceding a list of elements, modify the entire list of elements and do not modify the individual elements of the list. For example, “at least one of A, B, and C,” and similar language (e.g., “at least one selected from the group consisting of A, B, and C,” “at least one of A, B, or C”) may be construed as A only, B only, C only, or any combination of two or more of A, B, and C, such as, for instance, ABC, AB, BC, and AC.

It will be understood that elements and/or properties thereof may be recited herein as being “the same” or “equal” as other elements, and it will be further understood that elements and/or properties thereof recited herein as being “identical” to, “the same” as, or “equal” to other elements may be “identical” to, “the same” as, or “equal” to or “substantially identical” to, “substantially the same” as or “substantially equal” to the other elements and/or properties thereof. Elements and/or properties thereof that are “substantially identical” to, “substantially the same” as or “substantially equal” to other elements and/or properties thereof will be understood to include elements and/or properties thereof that are identical to, the same as, or equal to the other elements and/or properties thereof within manufacturing tolerances and/or material tolerances. Elements and/or properties thereof that are identical or substantially identical to and/or the same or substantially the same as other elements and/or properties thereof may be structurally the same or substantially the same, functionally the same or substantially the same, and/or compositionally the same or substantially the same. While the term “same,” “equal” or “identical” may be used in description of some example embodiments, it should be understood that some imprecisions may exist. Thus, when one element, value, and/or property is referred to as being the same as another element, value, and/or property, it should be understood that an element, value, and/or property is the same as another element, value, and/or property within a desired manufacturing or operational tolerance range (e.g., ±10%).

It will be understood that elements and/or properties thereof described herein as being “substantially” the same and/or identical encompasses elements and/or properties thereof that have a relative difference in magnitude that is equal to or less than 10%. Further, regardless of whether elements and/or properties thereof are modified as “substantially,” it will be understood that these elements and/or properties thereof should be construed as including a manufacturing or operational tolerance (e.g., ±10%) around the stated elements and/or properties thereof.

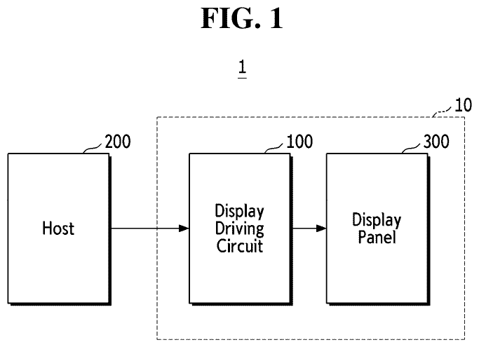

FIG. 1 is a block diagram illustrating a display system that includes a display device.

Referring to FIG. 1, a display system 1 may include a display device 10 and a host 200, and the display device 10 may include a display driving circuit 100 and a display panel 300.

The host 200 may generate image data to be displayed on the display panel 300 and provide the image data and a control command to the display driving circuit 100. For example, the control command may include setting information on luminance, gamma, frame frequency, operation mode of the display driving circuit 100, etc. The host 200 may provide a clock signal or a synchronization signal to the display driving circuit 100.

The host 200 may be a graphics processing unit (GPU), but is not limited thereto, and the host 200 may be implemented as various types of processors such as a central processing unit (CPU), a microprocessor, a multimedia processor, and an application processor. Also, the host 200 may be implemented as an integrated circuit (IC) or a system on chip (SoC).

The display device 10 may display an image corresponding to the image data provided by the host 200. The display device 10 may be a device in which the display driving circuit 100 and the display panel 300 are implemented as a single module. For example, the display driving circuit 100 may be mounted on a substrate of the display panel 300, or the display driving circuit 100 and the display panel 300 may be electrically connected to each other through a connection member such as a flexible printed circuit board (FPCB).

The display panel 300 is a display unit on which an image is displayed, and may be one of display devices, which display a two-dimensional image by receiving an electrically transmitted image signal, such as an organic light emitting diode (OLED) display, a thin film transistor-liquid crystal display (TFT LCD), a field emission display and a plasma display panel (PDP). The display driving circuit 100 may convert the image data received from the host 200 into a plurality of analog signals for driving the display panel 300, for example, a plurality of source voltages, and may supply the plurality of analog signals to the display panel 300. Accordingly, an image corresponding to the image data may be displayed on the display panel 300.

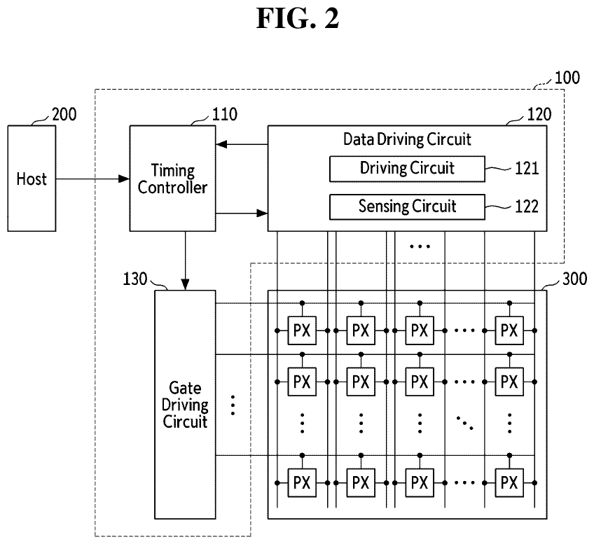

FIG. 2 is a block diagram illustrating a display device (e.g., the display device 10) that includes a display driving circuit 100.

Referring to FIG. 2, the display driving circuit 100 may include a data driving circuit 120, a gate driving circuit 130, and a timing controller 110.

A plurality of data lines and a plurality of gate lines may cross each other on the display panel 300, and pixels PX may be arranged in a matrix form for each crossing region. The display panel 300 may be a flat display panel such as a TFT-LCD, a PDP, an LED display, or an OLED, but is not limited thereto.

Each pixel PX may be connected to any one of the data lines and any one of the gate lines. Each pixel PX may be electrically connected to the data line to receive a source voltage from the data line in response to a gate pulse input through the gate lines. A display operation of the display panel 300 may be performed as one operation of the data driving circuit 120 and the gate driving circuit 130 under the control of the timing controller 110.

The data driving circuit 120 may include a driving circuit 121 and a sensing circuit 122. The driving circuit 121 may convert pixel data PD, which is a digital signal, into a source voltage for image display in accordance with a data timing control signal applied from the timing controller 110 during a display operation, and supply the converted source voltage to the data lines.

The sensing circuit 122 may receive characteristic information on a plurality of pixels PX from the display panel 300. The characteristic information may include, for example, information such as a threshold voltage and electron mobility of a driving transistor for driving a light emitting element included in each pixel. The characteristic information may be expressed as a characteristic voltage having a constant magnitude. Hereinafter, it is assumed that the characteristic voltage represents a threshold voltage of the driving transistor. The sensing circuit 122 may perform analog-to-digital conversion on the received characteristic voltage and provide a digital compensation signal to the timing controller 110.

The gate driving circuit 130 may generate gate pulses for image display based on a gate control signal during the display operation and then sequentially supply the gate pulses to the gate lines in a row-sequential manner.

The timing controller 110 may generate a data control signal for controlling an operation timing of the data driving circuit 120 and/or a gate control signal for controlling an operation timing of the gate driving circuit 130 based on timing signals such as a vertical synchronization signal, a horizontal synchronization signal, a dot clock signal, and a data enable signal.

The timing controller 110 may generate compensation data (or signal) for compensating for a threshold voltage deviation and/or an electron mobility deviation for the plurality of pixels PX based on the digital compensation signal received from the data driving circuit 120, provide pixel data PD, to which the generated compensation data (or signal) is applied, to the data driving circuit 120, and/or control the operation timing of the data driving circuit 120 or the gate driving circuit 130 in accordance with the generated compensation data.

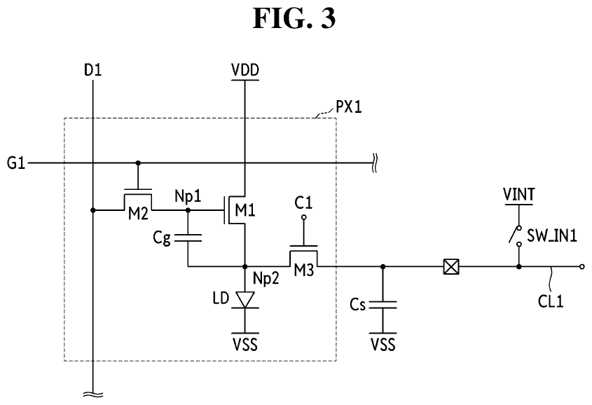

FIG. 3 is a circuit diagram illustrating a pixel of a display panel. Although a first pixel PX1 is shown in FIG. 3, the description of the first pixel PX1 may be applied to other pixels included in the display panel 300.

Referring to FIG. 3, the first pixel PX1 may include a light emitting element LD, transistors M1 to M3, and a storage capacitor Cg. The light emitting element LD may be connected between a first power terminal VDD and a second power terminal VSS. The first power terminal VDD may provide a higher voltage than the second power terminal VSS. The first power terminal VDD may be, for example, a power supply terminal. The second power terminal VSS may be, for example, a ground terminal. The light emitting element LD may operate by the first transistor M1. For example, the light emitting element LD may emit light with luminance corresponding to a current supplied from the first transistor M1.

According to some example embodiments, the light emitting element LD may include an organic light emitting diode (OLED) and a quantum dot organic light emitting diode. In some example embodiments, the light emitting element LD may include an inorganic light emitting diode (iLED) such as a micro light emitting diode and a quantum dot light emitting diode. Alternatively, in some example embodiments, the light emitting element LD may be an element in which an organic material and an inorganic material are complexly configured. Although FIG. 2 shows that the first pixel PX1 includes a single light emitting element LD, the first pixel PX1 may include a plurality of light emitting elements depending on example embodiments of the present disclosure.

The transistors M1, M2 and M3 may be implemented as N-type transistors, P-type transistors, or combination of the N-type transistor and the P-type transistor. The transistors M1, M2 and M3 may be implemented as various types of transistors such as a thin film transistor (TFT), a field effect transistor (FET), and a bipolar junction transistor (BJT). The first transistor M1 may drive the light emitting element LD. For example, the first transistor M1 may control the magnitude of a current flowing from the first power terminal VDD to the second power terminal VSS via the light emitting element LD in accordance with a gate signal. Hereinafter, the ‘driving transistor’ of each pixel refers to the first transistor M1 for driving the light emitting element LD in each pixel.

The second transistor M2 may be connected between the first data line D1 and a gate terminal of the first transistor M1. In addition, the gate terminal of the second transistor M2 may be connected to a first gate line G1. The second transistor M2 may be turned on in accordance with the gate signal provided through the first gate line G1 to electrically connect the first data line D1 to a first node Np1.

The third transistor M3 may be turned on in accordance with a control signal provided through a control line C1 to electrically connect a first channel line CL1 to a second node Np2.

The storage capacitor Cg may have one end connected to the first node Np1 and the other end connected to the second node Np2. The storage capacitor Cg may store a voltage corresponding to a voltage difference between the first node Np1 and the second node Np2.

One end of a first initialization switch SW_IN1 may be connected to the first channel line CL1, and the other end thereof may receive an initialization voltage VINT. When the first initialization switch SW_IN1 is turned on, the initialization voltage VINT may be provided to the first channel line CL1. When the first initialization switch SW_IN1 is turned off and the third transistor M3 is turned on, a characteristic voltage of the first pixel PX1 may be stored in a channel capacitor Cs. While the characteristic voltage is stored in the channel capacitor Cs, a voltage of the first channel line CL1 increases so that the first transistor M1 may be shifted from a saturation region (or a linear region) to a cut-off region (e.g., a gate-source voltage of the first transistor M1 is equal to or less than a threshold voltage). When the first transistor M1 reaches the cut-off region, storage of the characteristic voltage in the channel capacitor Cs may be terminated. Therefore, an end time point of characteristic sampling may be the time when the first transistor M1 is shifted to the cut-off region after the first initialization switch SW_IN1 is turned off. In some example embodiments, the first initialization switch SW_IN1 may be turned on and/or turned off based on a signal (or other input) received from the timing controller 110. In some example embodiments, the initialization voltage VINT may be received from the timing controller 110.

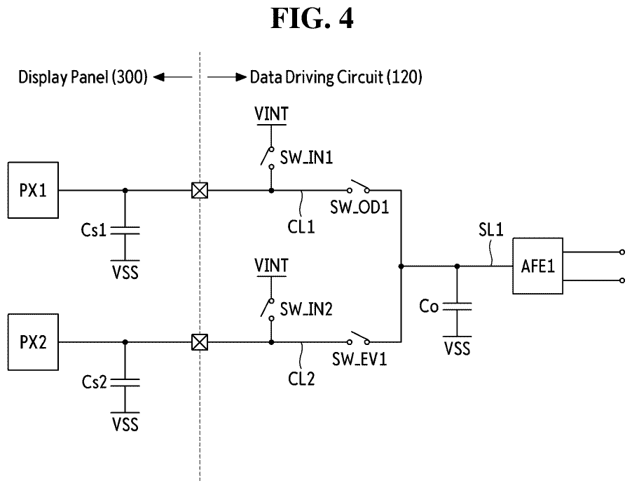

FIG. 4 is a circuit diagram illustrating a 2:1 MUX sensing method that performs 2-channel sensing with one analog front-end (AFE) circuit.

Referring to FIG. 4, the first and second pixels PX1 and PX2 of the display panel 300 of FIG. 2 may be electrically connected to the data driving circuit 120 through pads, respectively. The data driving circuit 120 may include a plurality of analog front-end (AFE) circuits including a first AFE circuit AFE1. In order to reduce an area occupied by the AFE circuit, a 2:1 MUX sensing method that performs two-channel sensing with one AFE circuit is used. When a first channel switch SW_OD1 is turned on, a characteristic voltage stored in a first channel capacitor Cs1 may be provided to the first AFE circuit AFE1 through the first channel line CL1 and a first sensing line SL1. A line capacitor Co may be connected to the first sensing line SL1. The line capacitor Co may be, for example, a parasitic capacitor generated by the first sensing line SL1.

When the first channel switch SW_OD1 is turned on, the first AFE circuit AFE1 may sense the characteristic voltage stored in the first channel capacitor Cs1 from the first channel line CL1 through the first sensing line SL1. Afterwards, when the first channel switch SW_OD1 is turned off and a second channel switch SW_EV1 is turned on, the first AFE circuit may sense a characteristic voltage stored in a second channel capacitor Cs2 from a second channel line CL2 through the first sensing line SL1.

When a voltage difference exists between the first sensing line SL1 and the second channel line CL2, charge sharing may occur between the line capacitor Co and the second channel capacitor Cs2 due to the voltage difference when the second channel switch SW_EV1 is turned on. Due to the charge sharing, a voltage offset may occur in the characteristic voltage when the characteristic voltage stored in the second channel capacitor Cs2 is sensed. The voltage offset may act as noise with respect to the characteristic voltage and the voltage offset may reduce accuracy of sensing. In some example embodiments, one or more of the first channel switch SW_OD1, the second channel switch SW_EV1, the first initialization switch SW_IN1, and the second initialization switch SW_IN2 may be turned on and/or turned off based on a signal (or other input) received from the timing controller 110.

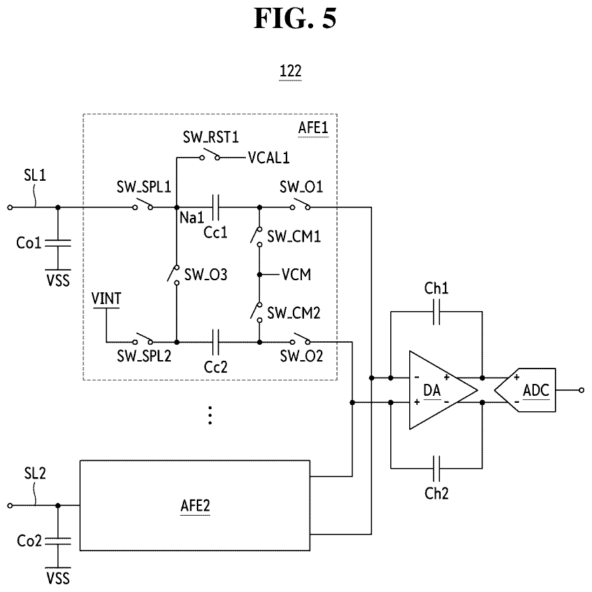

FIG. 5 is a circuit diagram illustrating an analog front-end (AFE) circuit.

Referring to FIG. 5, the sensing circuit 122 may include a plurality of AFE circuits AFE1 and AFE2, a differential amplifier DA, and an analog-to-digital converter ADC. Although FIG. 5 shows only a structure of the first AFE circuit AFE1, the description of the first AFE circuit AFE1 may be equally applied to the other AFE circuit. Although two AFE circuits are shown in FIG. 5, the sensing circuit 122 may include three or more AFE circuits depending on some example embodiments of the present disclosure.

The first AFE circuit AFE1 may include a first sampling capacitor Cc1 storing at least a portion of a sensed characteristic voltage, a first sampling switch SW_SPL1 providing the sensed characteristic voltage to the first sampling capacitor Cc1, a second sampling switch SW_SPL2 and a second sampling capacitor Cc2 for outputting a differential signal, first and second switches SW_CM1 and SW_CM2, first to third output switches SW_O1, SW_O2 and SW_O3, and a first reset switch SW_RST1.

When the first sampling switch SW_SPL1 is turned on, at least a portion of the sensed characteristic voltage may be provided to the first sampling capacitor Cc1. For example, the sensed characteristic voltage may be provided at one end of the first sampling capacitor Cc1. The second sampling switch SW_SPL2 may be turned on simultaneously with the first sampling switch SW_SPL1, or within a relatively short interval of each other, and thus an initialization voltage VINT may be formed, or otherwise, received at one end of the second sampling capacitor Cc2. Although FIG. 5 shows that the second sampling switch SW_SPL2 receives the initialization voltage VINT, the second sampling switch SW_SPL2 may receive another voltage (e.g., a power voltage VDD or a ground voltage VSS). The first and second switches SW_CM1 and SW_CM2 may be simultaneously turned on or within a relatively short interval of each other. A time period at which the first and second switches SW_CM1 and SW_CM2 are turned on may partially overlap a time period at which the first and second sampling switches SW_SPL1 and SW_SPL2 are turned on. When the first and second switches SW_CM1 and SW_CM2 are turned on, a common mode voltage VCM may be provided to the other ends of the first sampling capacitor Cc1 and the second sampling capacitor Cc2.

The first to third output switches SW_O1, SW_O2 and SW_O3 may be simultaneously turned on, or within a relatively short interval of each other. When the first to third output switches SW_O1, SW_O2 and SW_O3 are turned on, a difference between voltages stored in the first and second sampling capacitors Cc1 and Cc2 may be provided to the differential amplifier DA as a differential signal. The differential amplifier DA and gain capacitors Ch1 and Ch2 may amplify the received differential signal and provide the amplified differential signal to the analog-to-digital converter ADC. The analog-to-digital converter ADC may perform analog-to-digital conversion for the amplified differential signal to provide a digital compensation signal to the timing controller 110.

One end of the first reset switch SW_RST1 may be connected to a node Na1 between the first sampling switch SW_SPL1 and the first sampling capacitor Cc1, and the other end thereof may receive a first compensation voltage VCAL1. When the first reset switch SW_RST1 is turned on, the first compensation voltage VCAL1 may be provided to the node Na1 between the first sampling switch SW_SPL1 and the first sampling capacitor Cc1. When the first sampling switch SW_SPL1 is turned on, and when there is a voltage difference between each channel line (e.g., the first channel line CL1 of the first pixel PX1 of FIG. 3) and the node Na1, a voltage offset may occur as described above. For example, the first compensation voltage VCAL1 may have a voltage level similar in some respects to or the same as that of the characteristic voltage of each pixel. As an example, the first compensation voltage VCAL1 may have a voltage level substantially the same as that of the characteristic voltage of the first pixel PX1. Accordingly, the first compensation voltage VCAL1 may reduce the voltage difference between each channel line and the node Na1. In some example embodiments, one or more of the first sampling switch SW_SPL1, the second sampling switch SW_SPL2, the first and second switches SW_CM1 and SW_CM2, the first to third output switches SW_O1, SW_O2 and SW_O3, and the first reset switch SW_RST1 may be operated (e.g., turned on and/or turned off) based on a control or signal provided by the timing controller 110. In some example embodiments, the initialization voltage VINT and/or the first compensation voltage VCAL1 may be received from the timing controller 110.

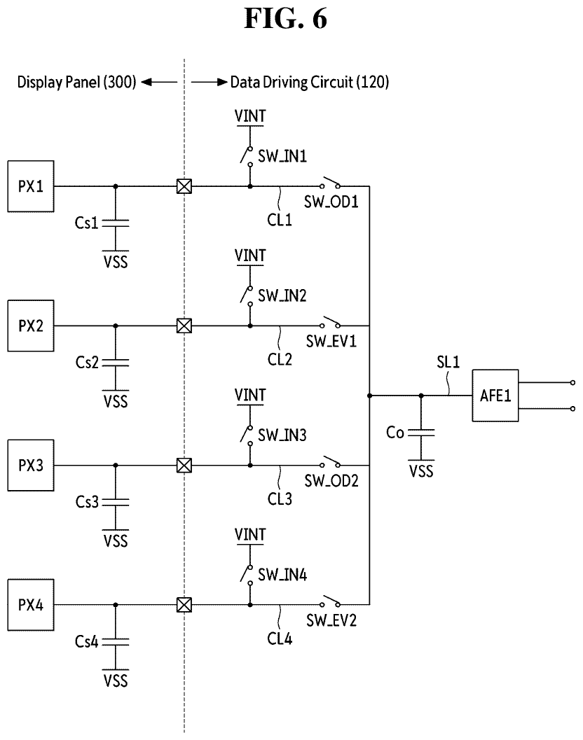

FIG. 6 is a circuit diagram illustrating a 4:1 MUX sensing method that performs 4-channel sensing with one analog front-end (AFE) circuit.

Referring to FIG. 6, first to fourth pixels PX1, PX2, PX3, and PX4 of the display panel 300 may be electrically connected to the data driving circuit 120 through pads. The connections of the third and fourth pixels PX3 and PX4 to the data driving circuit 120 may be the same as or similar in some respects to the connections of the first and second pixels PX1 and PX2 to the data driving circuit 120 as illustrated in FIG. 4, and can be best understood with reference thereto. The data driving circuit 120 may include a plurality of AFE circuits including a first AFE circuit AFE1. As discussed above, the 2:1 MUX sensing method that performs two-channel sensing with one AFE circuit is used to reduce an area occupied by the AFE circuit. In order to further reduce an area occupied by the AFE circuit, the 4:1 MUX sensing method of performing 4-channel sensing with one AFE circuit may be used. When the first channel switch SW_OD1 is turned on, the characteristic voltage stored in the first channel capacitor Cs1 may be provided to the first AFE circuit AFE1 through the first channel line CL1 and the first sensing line SL1. In some example embodiments, the line capacitor Co may be connected to the first sensing line SL1. The line capacitor Co may be, for example, a parasitic capacitor generated by the first sensing line SL1.

When the first channel switch SW_OD1 is turned on, the first AFE circuit AFE1 may sense the characteristic voltage stored in the first channel capacitor Cs1 from the first channel line CL1 through the first sensing line SL1. When the first channel switch SW_OD1 is turned off and the second channel switch SW_EV1 is turned on, the first AFE circuit AFE1 may sense the characteristic voltage stored in the second channel capacitor Cs2 from the second channel line CL2 through the first sensing line SL1. When the second channel switch SW_EV1 is turned off and a third channel switch SW_OD2 is turned on, the first AFE circuit AFE1 may sense a characteristic voltage stored in a third channel capacitor Cs3 from a third channel line CL3 through the first sensing line SL1. When the third channel switch SW_OD2 is turned off and a fourth channel switch SW_EV2 is turned on, the first AFE circuit AFE1 may sense a characteristic voltage stored in a fourth channel capacitor Cs4 from a fourth channel line CL4 through the first sensing line SL1.

The order in which each channel switch is turned on and turned off is not limited by any particular order. For example, the switches may be turned on and off in the order of the third channel switch SW_OD2, the fourth channel switch SW_EV2, the first channel switch SW_OD1, and the second channel switch SW_EV1. Alternatively, the switches may be turned on and off in the order of the second channel switch SW_EV1, the third channel switch SW_OD2, the fourth channel switch SW_EV2, and the first channel switch SW_OD1. The order in which each channel switch is turned on and off may be different for each AFE circuit.

When there is a voltage difference between the first sensing line SL1 and the second channel line CL2, charge sharing may occur between the line capacitor Co and the second channel capacitor Cs2 due to the voltage difference when the second channel switch SW_EV1 is turned on. Due to the charge sharing, a voltage offset may occur in a voltage sensing value when the characteristic voltage stored in the second channel capacitor Cs2 is sensed. The voltage offset may act as noise with respect to the voltage sensing value. The voltage offset may also occur when the second channel switch SW_EV1 is turned off and the third channel switch SW_OD2 is turned on, or when the third channel switch SW_OD2 is turned off and the fourth channel switch SW_EV2 is turned on. In some example embodiments, one or more of the first to fourth channel switches SW_OD1, SW_EV1, SW_OD2 and SW_EV2, and the first to fourth initialization switches SW_IN1, SW_IN2, SW_IN3 and SW_IN4 may be turned on and/or turned off based on a signal (or other input) received from the timing controller 110.

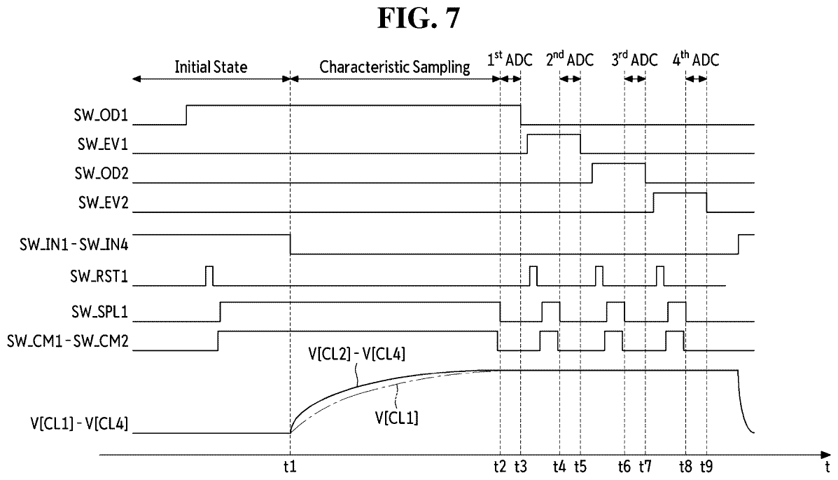

FIG. 7 is a timing diagram illustrating a method of operating an analog front-end (AFE) circuit.

Operation timings of the first to fourth channel switches SW_OD1, SW_EV1, SW_OD2 and SW_EV2, the first to fourth initialization switches SW_IN1, SW_IN2, SW_IN3 and SW_IN4, the first reset switch SW_RST1, the first sampling switch SW_SPL1, and the first and second switches SW_CM1 and SW_CM2, and changes in voltages V[CL1], V[CL2], V[CL3] and V[CL4] of channel lines according to the operation timings will be described with reference to FIGS. 5, 6 and 7. It is assumed that the channel switches of the first AFE circuit AFE1 are turned on and off in the order of the first channel switch SW_OD1, the second channel switch SW_EV1, the third channel switch SW_OD2, and the fourth channel switch SW_EV2. At a first time t1, the first to fourth initialization switches SW_IN1, SW_IN2, SW_IN3 and SW_IN4 are turned off, and a characteristic sampling operation may be performed. The characteristic sampling operation refers to an operation in which the characteristic voltage of each pixel is stored in each channel capacitor.

During the characteristic sampling operation, the first channel switch SW_OD1 may be turned on, and the second to fourth channel switches SW_EV1, SW_OD2, SW_EV2 may be turned off. Therefore, in case of the first pixel PX1, the driving transistor needs to charge all of the first channel capacitor Cs1, the line capacitor Co, and the first sampling capacitor Cc1 for characteristic sampling, but in case of the second to fourth pixels PX2, PX3 and PX4, driving transistors of the second to fourth pixels PX2, PX3 and PX4 charge each of the channel capacitors Cs2, Cs3, and Cs4 for characteristic sampling. Therefore, a voltage change rate (voltage gradient) of the first channel line CL1 may be less than voltage change rates (voltage gradients) of the second to fourth channel lines CL2, CL3 and CL4. For this reason, when the time for characteristic sampling is not sufficiently secured, a voltage offset in a direction (−) may occur in the characteristic voltage sensed in the first channel line CL1. In this case, the voltage offset in the direction (−) may indicate that a measured voltage value is less than an ideal voltage value.

The first reset switch SW_RST1 may be turned on before the first sampling switch SW_SPL1 is turned on, whereby the first compensation voltage VCAL1 may be provided to the node Na1. A time period at which the first reset switch SW_RST1 is turned on may not overlap a time period at which the first sampling switch SW_SPL1 is turned on. Analog-to-digital conversion (1st ADC) of a first characteristic voltage may be performed from a second time t2 when the first sampling switch SW_SPL1 is turned off to a third time t3 when the first channel switch SW_OD1 is turned off.

The second channel switch SW_EV1 may be turned on after the first channel switch SW_OD1 is turned off. The first reset switch SW_RST1 may be turned on before the first sampling switch SW_SPL1 is turned on, whereby the first compensation voltage VCAL1 may be provided to the node Na1. Analog-to-digital conversion (2nd ADC) of a second characteristic voltage may be performed from a fourth time t4 when the first sampling switch SW_SPL1 is turned off to a fifth time t5 when the second channel switch SW_EV1 is turned off.

The third channel switch SW_OD2 may be turned on after the second channel switch SW_EV1 is turned off. The first reset switch SW_RST1 may be turned on before the first sampling switch SW_SPL1 is turned on, whereby the first compensation voltage VCAL1 may be provided to the node Na1. Analog-to-digital conversion (3rd ADC) of a third characteristic voltage may be performed from a sixth time t6 when the first sampling switch SW_SPL1 is turned off to a seventh time t7 when the third channel switch SW_OD2 is turned off.

The fourth channel switch SW_EV2 may be turned on after the third channel switch SW_OD2 is turned off. The first reset switch SW_RST1 may be turned on before the first sampling switch SW_SPL1 is turned on, whereby the first compensation voltage VCAL1 may be provided to the node Na1. Analog-to-digital conversion (4th ADC) of a fourth characteristic voltage may be performed from an eighth time t8 when the first sampling switch SW_SPL1 is turned off to a ninth time t9 when the fourth channel switch SW_EV2 is turned off.

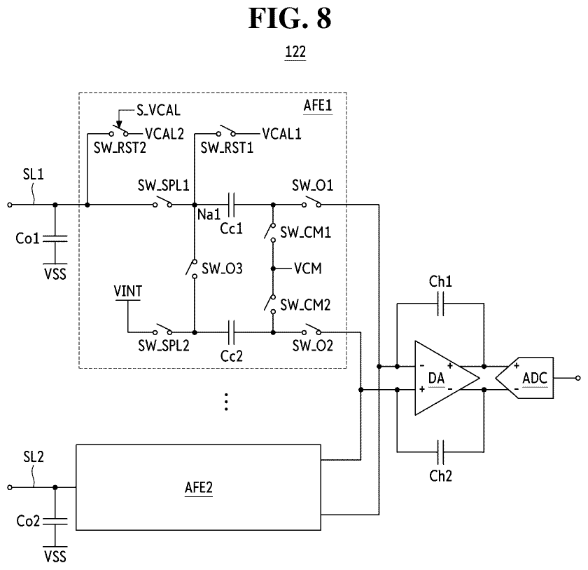

FIG. 8 is a circuit diagram illustrating an analog front-end (AFE) circuit.

The analog front-end (AFE) circuit of FIG. 8 may be same as or similar in some respects to the analog front-end (AFE) circuit of FIG. 5, and therefore may be best understood with reference thereto where like numerals indicate like elements not described again in detail. Referring to FIG. 8, the sensing circuit 122 may include a plurality of AFE circuits AFE1 and AFE2, a differential amplifier DA, and an analog-to-digital converter ADC. Although FIG. 8 shows only a structure of the first AFE circuit AFE1, the description of the first AFE circuit AFE1 may be equally applied to the AFE circuit AFE2.

The first AFE circuit AFE1 may include a first sampling capacitor Cc1 storing at least a portion of a sensed characteristic voltage, a first sampling switch SW_SPL1 providing the sensed characteristic voltage to the first sampling capacitor Cc1, a second sampling switch SW_SPL2 and a second sampling capacitor Cc2 for outputting a differential signal, first and second switches SW_CM1 and SW_CM2, first to third output switches SW_O1, SW_O2 and SW_O3, and the first reset switch SW_RST1, and may further include a second reset switch SW_RST2.

One end of the second reset switch SW_RST2 may be connected to the first sensing line SL1, and the other end thereof may receive a second compensation voltage VCAL2. In some example embodiments, one end of the second reset switch SW_RST2 may be connected to a node that is between the first sampling switch SW_SPL1 and a node to which each channel line and each sensing line are connected. The second compensation voltage VCAL2 may have substantially the same level as or different level from the first compensation voltage VCAL1. Hereinafter, ‘substantially the same’ is used herein may mean that two or more elements, values, and/or properties are exactly same as each other or are within a certain, desirable, acceptable degree of tolerance. When the second reset switch SW_RST2 is turned on, the second compensation voltage VCAL2 may be provided to the first sensing line SL1. The second reset switch SW_RST2 may be turned on and/or off depending on a first reset signal S_VCAL. In some example embodiments, the first reset signal S_VCAL and/or the second compensation voltage VCAL2 may be received from the timing controller 110.

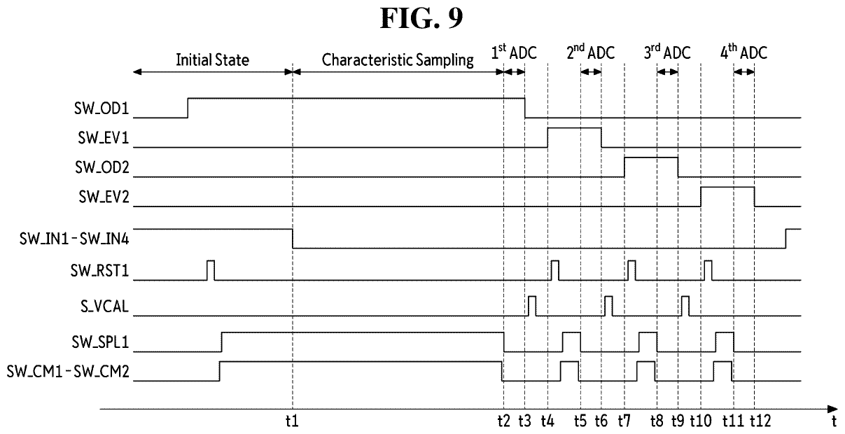

FIG. 9 is a timing diagram illustrating a method of operating an analog front-end (AFE) circuit. The timing diagram of FIG. 9 may be same as or similar in some respects to the timing diagram of FIG. 7, and therefore may be best understood with reference thereto where like numerals indicate like elements not described again in detail.

Operation timings of the first to fourth channel switches SW_OD1, SW_EV1, SW_EV1 and SW_EV2, the first to fourth initialization switches SW_IN1, SW_IN2, SW_IN3 and SW_IN4, the first reset switch SW_RST1, the first sampling switch SW_SPL1, and the first and second switches SW_CM1 and SW_CM2 will be described with reference to FIGS. 6, 8 and 9. The description of the operation of the second reset switch SW_RST2 will be replaced with the description of the first reset signal S_VCAL for controlling the second reset switch SW_RST2. The second reset switch SW_RST2 may be turned on when the first reset signal S_VCAL is in a logic high state. When the first reset signal S_VCAL is in a logic low state, the second reset switch SW_RST2 may be turned off.

It is assumed that the channel switches of the first AFE circuit AFE1 are turned on and turned off in the order of the first channel switch SW_OD1, the second channel switch SW_EV1, the third channel switch SW_OD2, and the fourth channel switch SW_EV2. The first reset signal S_VCAL may be maintained in the logic high state between the time t3 when the first channel switch SW_OD1 is turned off and the time t4 when the second channel switch SW_EV1 is turned on. Also, the first reset signal S_VCAL may be maintained in the logic high state between the time t6 when the second channel switch SW_EV1 is turned off and the time t7 when the third channel switch SW_OD2 is turned on. Also, the first reset signal S_VCAL may be maintained in the logic high state between the time t9 when the third channel switch SW_OD2 is turned off and a time t10 when the fourth channel switch SW_EV2 is turned on. A time period at which the first reset signal S_VCAL maintains the logic high may not overlap a time period at which each of the channel switches SW_OD1, SW_EV1, SW_OD2 and SW_EV2 are maintained in the turn-on state.

The second reset switch SW_RST2 may provide the second compensation voltage VCAL2 to the first sensing line SL1. For example, the second compensation voltage VCAL2 may have a level same as or similar in some respects to that of a threshold voltage of a driving transistor of each pixel. Accordingly, the second compensation voltage VCAL2 may reduce a voltage difference between the second to fourth channel lines CL2, CL3 and CL4 and the first sensing line SL1, which may occur when the second to fourth channel switches SW_EV1, SW_OD2 and SW_EV2 are turned on. Since the voltage difference is reduced, a voltage offset generated in sensing values when characteristic voltages of the second to fourth channels are sensed may be reduced or alleviated. A gate driving circuit (e.g., the gate driving circuit 130) may therefore sense driving characteristics of each pixel with a relatively higher accuracy.

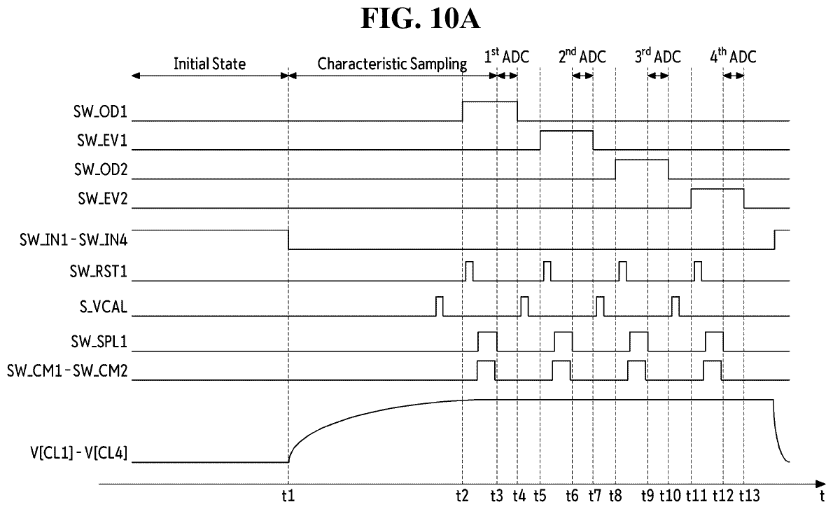

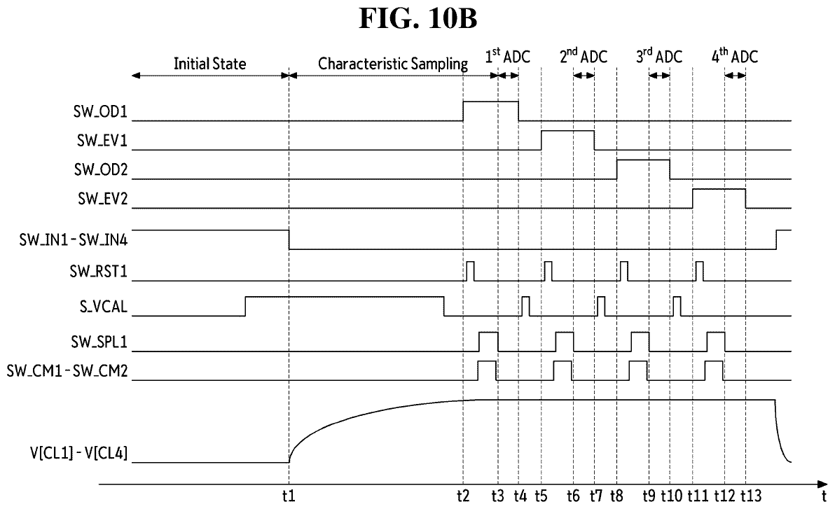

FIG. 10A and FIG. 10B are timing diagrams illustrating a method of operating an analog front-end (AFE) circuit. The timing diagrams of FIGS. 10A and 10B may be same as or similar in some respects to the timing diagram of FIGS. 7 and 9, and therefore may be best understood with reference thereto where like numerals indicate like elements not described again in detail.

Operation timings of the first to fourth channel switches SW_OD1, SW_EV1, SW_OD2 and SW_EV2, the first to fourth initialization switches SW_IN1, SW_IN2, SW_IN3 and SW_IN4, the first reset switch SW_RST1, the first sampling switch SW_SPL1, and the first and second switches SW_CM1 and SM_CM2, and changes in voltages V[CL1], V[CL2], V[CL3] and V[CL4] of channel lines according to the operation timings will be described with reference to FIGS. 6, 8, 10A and 10B. The description of the operation of the second reset switch SW_RST2 will be replaced with the description of the operation of the first reset signal S_VCAL for controlling the second reset switch SW_RST2. The second reset switch SW_RST2 may be turned on when the first reset signal S_VCAL is in a logic high state. When the first reset signal S_VCAL is in a logic low state, the second reset switch SW_RST2 may be turned off.

Characteristic sampling may start from the first time t1 at which each of the initialization switches SW_IN1, SW_IN2, SW_IN3 and SW_IN4 is turned off. As the characteristic sampling starts, the characteristic voltage may be stored in the first to fourth channel capacitors Cs1, Cs2, Cs3 and Cs4 in the form of a voltage. While the characteristic voltage is stored in the first to fourth channel capacitors Cs1, Cs2, Cs3 and Cs4, the voltages of the first to fourth channel lines CL1, CL2, CL3, and CL4 increase so that the driving transistors of the first to fourth pixels PX1, PX2, PX3 and PX4 may be shifted from the saturation region (or the linear region) to the cut-off region (e.g., a state in which a gate-source voltage of the driving transistor of each pixel is equal to or less than a threshold voltage). The storage of the characteristic voltage may be completed at a second time t2 at which the first transistor M1 is shifted from the saturation region (or the linear region) to the cut-off region. The first channel switch SW_OD1 may be turned on after the time t2 at which the storage of the characteristic voltage is completed. As an example, the time at which the first channel switch SW_OD1 maintains a turn-on state may be the same as the time at which the second channel switch SW_EV1 maintains a turn-on state.

In some example embodiments, as illustrated in FIG. 10A, a first reset signal S_VCAL may transition to a logic high level and subsequently to a logic low level between the first time t1 at which each of the initialization switches SW_IN1, SW_IN2, SW_IN3, and SW_IN4 is turned OFF and the second time t2 at which a first channel switch SW_OD1 is turned on. However, example embodiments of the disclosure are not limited thereto. In some example embodiments, as illustrated in FIG. 10B, the first reset signal S_VCAL may transition to a logic high level and subsequently to a logic low level before the first time t1 at which each of the initialization switches SW_IN1, SW_IN2, SW_IN3, and SW_IN4 is turned off.

Since the first channel switch SW_OD1 is turned on after the time t2 at which the storage of the characteristic voltage is completed and maintains a turn-off state before the time t2, in case of the first pixel PX1, the driving transistor may not charge all of the first pixel capacitor Cs1, the line capacitor Co, and the first sampling capacitor Cc1 for characteristic sampling, and may charge only the pixel capacitor Cs1. Accordingly, the voltage change rate (voltage gradient) of the first channel line CL1 may be substantially the same as the voltage change rates (voltage gradients) of the second to fourth channel lines CL2, CL3 and CL4. Accordingly, even when a time for characteristic sampling may not be sufficiently long, a voltage offset generated in the first channel line CL1 may be reduced or alleviated. A gate driving circuit (e.g., the gate driving circuit 130) may thus sense driving characteristics of each pixel with a relatively higher accuracy.

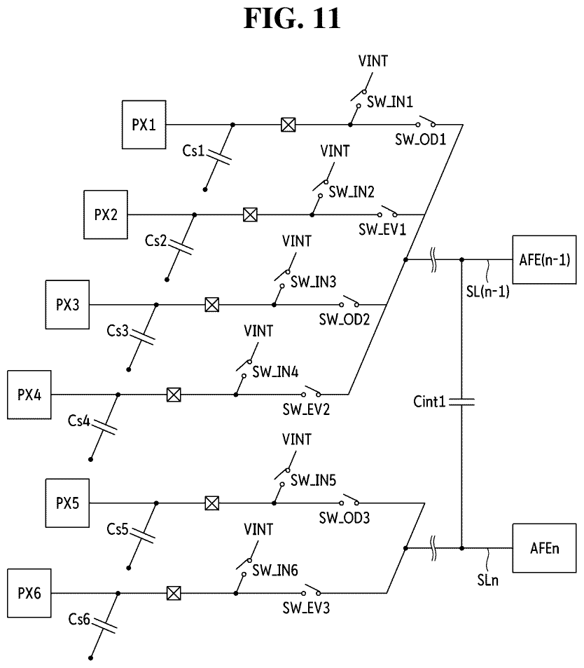

FIG. 11 is a circuit diagram illustrating a coupling effect between an AFE circuit performing 4:1 MUX sensing and an AFE circuit performing 2:1 MUX sensing, wherein these AFE circuits are adjacent to each other.

When the number of channels connected to the gate driving circuit is an even number and is not a multiple of 4 (e.g., 966 channels), the sensing circuit 122 may include a plurality of AFE circuits performing 4:1 MUX sensing and an AFE circuit performing 2:1 MUX sensing. Referring to FIG. 11, an (n)th AFE circuit AFEn may be an AFE circuit performing 2:1 MUX sensing, and an (n-1)th AFE circuit AFE(n-1) adjacent to the (n)th AFE circuit AFEn may be an AFE circuit performing 4:1 MUX sensing. The (n)th AFE circuit AFEn may perform 2:1 MUX sensing in the same or similar manner as the 2:1 MUX sensing method discussed above with reference to FIG. 4, and a description thereof is omitted herein for the sake of brevity.

The first channel switch SW_OD1 and a fifth channel switch SW_OD3 may be simultaneously turned on and off or within a relatively short duration of each other. The second channel switch SW_EV1 and a sixth channel switch SW_EV3 may be simultaneously turned on and off, or within a relatively short duration of each other. The sensing line of each AFE circuit may be extended in the sensing circuit 122, and thus coupling between adjacent sensing lines may occur. For example, a coupling capacitor Cint1 may be generated by coupling between an (n-1)th sensing line SL(n-1) and an (n)th sensing line SLn, which are adjacent to each other.

As described above, channel switches of the (n-1)th AFE circuit AFE(n-1) may be turned on and off in the order of the first channel switch SW_OD1, the second channel switch SW_EV1, the third channel switch SW_OD2, and the fourth channel switch SW_EV2, but may be turned on and off in the order of the third channel switch SW_OD2, the fourth channel switch SW_EV2, the first channel switch SW_OD1, and the second channel switch SW_EV1. It is assumed that the channel switches of the (n-1)th AFE circuit AFE(n-1) are turned on and off in the order of the third channel switch SW_OD2, the fourth channel switch SW_EV2, the first channel switch SW_OD1, and the second channel switch SW_EV1. When the third channel switch SW_OD2 and the fourth channel switch SW_EV2 are turned on and off, the fifth channel switch SW_OD3 and the sixth channel switch SW_EV3 may be maintained in a turn-off state. While the fifth channel switch SW_OD3 and the sixth channel switch SW_EV3 are in a turn-off state, the (n)th sensing line SLn is not electrically connected to fifth and sixth pixels PX5 and PX6, and may be in a floating state.

While the (n)th sensing line SLn is in a floating state, a voltage of the (n)th sensing line SLn is gradually discharged, and thus the voltage level of the sensing line may gradually decrease. Due to coupling, the (n)th sensing line SLn may cause a voltage offset in a direction (−) in the (n-1)th sensing line SL(n-1) adjacent thereto. Also, when the first compensation voltage VCAL1 is supplied to the (n)th sensing line SLn by the first reset switch SW_RST1, a voltage level of the (n)th sensing line SLn may rapidly increase or at a relatively faster rate, thereby causing a voltage offset in a direction (+) in the (n-1)th sensing line SL(n-1) adjacent to (or preceding) the (n)th sensing line SLn. In this case, the voltage offset in the direction (+) may mean or indicate that a measured voltage value is more excessive than an ideal voltage value.

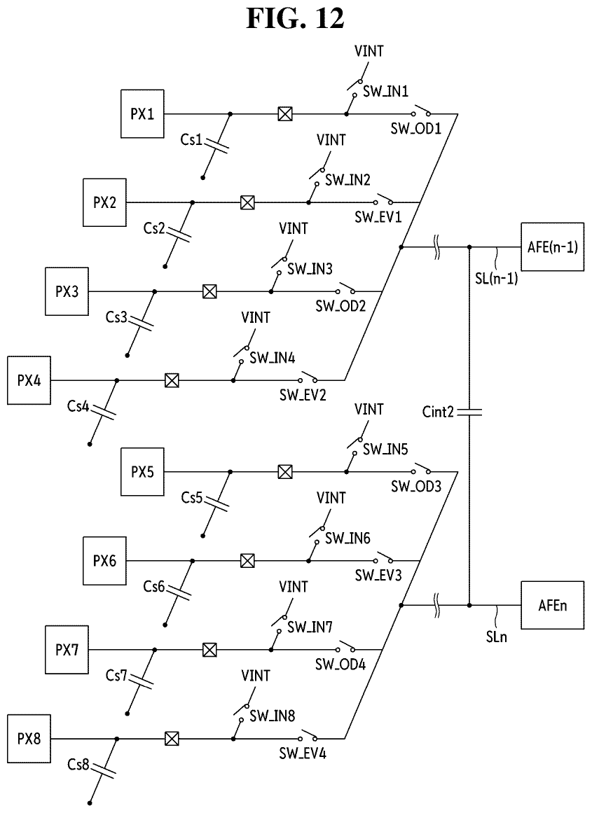

FIG. 12 is a circuit diagram illustrating a coupling effect between an AFE circuit performing 4:1 MUX sensing and an AFE circuit adjacent thereto and in a disabled state. The connections of fifth to eighth pixels PX5, PX6, PX7, and PX8 to the data driving circuit 120 may be the same as or similar in some respects to the connections of the first to fourth pixels PX1, PX2, PX3, and PX4 to the data driving circuit 120 as illustrated in FIG. 6, and can be best understood with reference thereto.

Some of the channels connected to the gate driving circuit may be in a disabled state. Referring to FIG. 12, channels (or channel lines) connected to the (n-1)th AFE circuit AFE(n-1) may be in an enabled state, and channels (or channel lines) connected to the (n)th AFE circuit AFEn may be in a disabled state. For example, in a disabled state, channel sensing of the channels connected to the (n)th AFE circuit AFEn may not be performed. For example, when the third channel switch SW_OD2 and the fourth channel switch SW_EV2 are turned on and off, the fifth channel switch SW_OD3, the sixth channel switch SW_EV3, a seventh channel switch SW_OD4, and an eighth channel switch SW_EV4 may be maintained in a turn-off state. The (n)th sensing line SLn may be in a floating state while channel sensing of the (n-1)th AFE circuit AFE(n-1) adjacent thereto is being performed. As described above, the (n)th sensing line SLn in the floating state may cause a voltage offset on the (n-1)th sensing line SL(n-1) adjacent thereto.

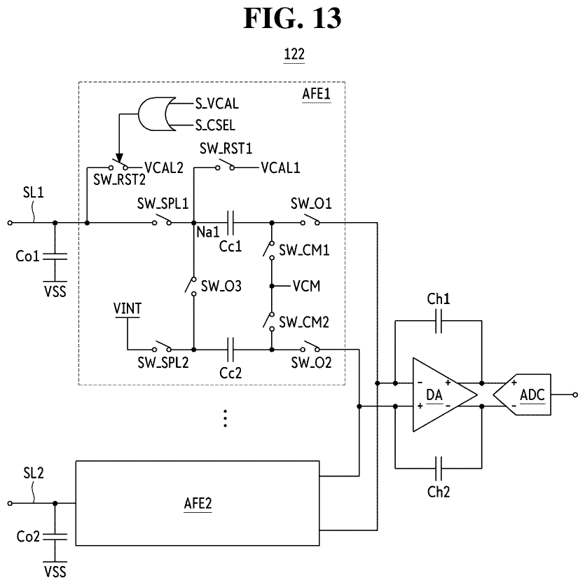

FIG. 13 is a circuit diagram illustrating an analog front-end (AFE) circuit.

The circuit diagram of FIG. 13 may be same as or similar in some respects to the circuit diagrams of FIGS. 5 and 8, and therefore may be best understood with reference thereto where like numerals indicate like elements not described again in detail. Referring to FIG. 13, the sensing circuit 122 may include a plurality of AFE circuits AFE1 and AFE2, a differential amplifier DA, and an analog-to-digital converter ADC. Although FIG. 13 shows a structure of the first AFE circuit AFE1, the description of the first AFE circuit AFE1 may be equally applied to the AFE circuit AFE2 and any additional AFE circuits that may be included in the sensing circuit 122.

The first AFE circuit AFE1 may include a first sampling capacitor Cc1 storing at least a portion of a sensed characteristic voltage, a first sampling switch SW_SPL1 providing the sensed characteristic voltage to the first sampling capacitor Cc1, a second sampling switch SW_SPL2 and a second sampling capacitor Cc2 for outputting a differential signal, first and second switches SW_CM1 and SW_CM2, first to third output switches SW_O1, SW_O2 and SW_O3, a first reset switch SW_RST1, and a second reset switch SW_RST2. One end of the second reset switch SW_RST2 may be connected to the first sensing line SL1, and the other end thereof may receive a second compensation voltage VCAL2. The second compensation voltage VCAL2 may have substantially the same level as or a different level from the first compensation voltage VCAL1. When the second reset switch SW_RST2 is turned on, the second compensation voltage VCAL2 may be provided to the first sensing line SL1. The second reset switch SW_RST2 may be turned on or off depending on the first reset signal S_VCAL or a second reset signal S_CSEL. For example, the second reset switch SW_RST2 may be turned on when both the first and second reset signals S_VCAL and S_CSEL are in a logic high state, or when the first reset signal S_VCAL is in a logic high state or when the second reset signal S_CSEL is in a logic high state, and may be turned off when both the first and second reset signals S_VCAL and S_CSEL are in a logic low state. In some example embodiments, the second reset signal S_CSEL may be received from the timing controller 110.

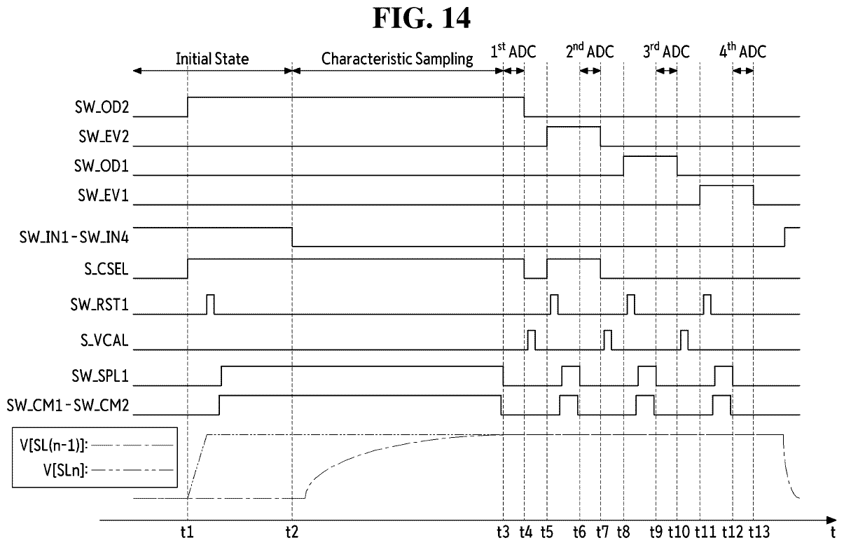

FIG. 14 is a timing diagram illustrating a method of operating an analog front-end (AFE) circuit. The timing diagram of FIG. 14 may be same as or similar in some respects to the timing diagram of FIGS. 7 and 9, and therefore may be best understood with reference thereto where like numerals indicate like elements not described again in detail.

Operation timings of the first to fourth channel switches SW_OD1, SW_EV1, SW_OD2 and SW_EV2, the first to fourth initialization switches SW_IN1, SW_IN2, SW_IN3 and SW_IN4, the first reset switch SW_RST1, the first sampling switch SW_SPL1, and the first and second switches SW_CM1 and SM_CM2, and changes in voltages V[SL(n-1)] and V[SLn] of sensing lines of the (n-1)th AFE circuit AFE(n-1) according to the operation timings will be described with reference to FIGS. 11, 13 and 14. The description of the operation of the second reset switch SW_RST2 will be replaced with the description of the operation of the first and second reset signals S_VCAL and S_CSEL for controlling the second reset switch SW_RST2. It is assumed that the channel switches of the (n-1)th AFE circuit AFE(n-1) are turned on and off in the order of the third channel switch SW_OD2, the fourth channel switch SW_EV2, the first channel switch SW_OD1, and the second channel switch SW_EV1.

The first reset signal S_VCAL may be the same as or similar in some respects to the first reset signal S_VCAL of FIG. 9. For example, the second reset signal S_CSEL may be in a logic high state until the fourth channel switch SW_EV2 is turned off. The second reset signal S_CSEL may be in a logic high state from the time t1 when the third channel switch SW_OD2 is turned on to the time t7 when the fourth channel switch SW_EV2 is turned off. Alternatively, a state of the second reset signal S_CSEL may be based on states of the third channel switch SW_OD2 and the fourth channel switch SW_EV2. For example, the second reset signal S_CSEL may maintain a logic high state during a time period (t1 to t4) at which the third channel switch SW_OD2 maintains a turn-on state and a time period (t5 to t7) at which the fourth channel switch SW_EV2 maintains a turn-on state. For example, the second reset signal S_CSEL may be provided to an AFE circuit performing 2-channel sensing in FIG. 11 or an AFE circuit connected to the disable channel of FIG. 12, but is not limited thereto, and may also be provided to other AFE circuits.

In FIG. 14, the channel switches of the (n-1)th AFE circuit AFE(n-1) are turned on and off in the order of the third channel switch SW_OD2, the fourth channel switch SW_EV2, the first channel switch SW_OD1, and the second channel switch SW_EV1. However, in some example embodiments, the order of turning on and off the channel switches of the (n-1)th AFE circuit AFE(n-1) may be changed, as will be apparent to one skilled in the art.

As described above, while the (n-1)th AFE circuit AFE(n-1) performs sensing for the third and fourth pixels PX3 and PX4, the (n)th AFE circuit AFEn may not perform channel sensing, and thus the (n)th sensing line SLn may be in a floating state. The second reset switch SW_RST2 may provide the second compensation voltage VCAL2 to the (n)th sensing line SLn, which is in a floating state, in accordance with the second reset signal S_CSEL. Therefore, voltage change of the (n)th sensing line SLn may be alleviated or reduced, and thus a voltage offset may not be caused in the sensing line of the AFE circuit adjacent to the (n)th sensing line SLn. As a result, a gate driving circuit (e.g., gate driving circuit 130) that senses driving characteristics of each pixel with a relatively improved accuracy may be obtained.

According to some example embodiments, a display driving circuit comprises a data driving circuit including, a first analog front-end (AFE) circuit configured to sense a first characteristic voltage from a first channel line connected to a first pixel through a first sensing line while a first channel switch is in a turn-on state, and configured to sense a second characteristic voltage from a second channel line connected to a second pixel through the first sensing line while a second channel switch is in a turn-on state; and an analog-to-digital converter configured to convert an output signal received from the first AFE circuit into a digital compensation signal. The first AFE circuit includes, a sampling capacitor configured to store at least a portion of a sensed characteristic voltage, a sampling switch configured to selectively provide the sensed characteristic voltage to the sampling capacitor, and a first reset switch having a first end connected to the first sensing line and a second end connected to a first compensation voltage, and configured to operate in accordance with a first reset signal. The display driving circuit further comprises a timing controller configured to generate the first reset signal. The first reset switch is configured to selectively provide the first compensation voltage to the first sensing line in response to the first reset signal turning on the first reset switch, the first reset switch is turned on before the second channel switch is turned on, and the second channel switch is turned on after the first channel switch is turned off.

According to some example embodiments, the timing controller is further configured to generate a second reset signal. The first reset switch is configured to operate in accordance with the first reset signal or the second reset signal, and the first reset switch is configured to selectively provide the first compensation voltage to the first sensing line in response to the second reset signal turning on the first reset switch, and the first reset switch is turned on before the second channel switch is turned on.

According to some example embodiments, in response to the second reset signal turning on the first reset switch, the first reset switch is configured to selectively provide the first compensation voltage to the first sensing line while the first channel switch is in a turn-on state or the second channel switch is in a turn-on state.

According to some example embodiments, the first reset switch is configured to operate based on an OR operation between the first reset signal and the second reset signal.

According to some example embodiments, the data driving circuit further comprises a second AFE circuit adjacent to the first AFE circuit and configured to, sense a third characteristic voltage from a third channel line connected to a third pixel through a second sensing line while a third channel switch is in a turn-on state, sense a fourth characteristic voltage from a fourth channel line connected to a fourth pixel through the second sensing line while a fourth channel switch is in a turn-on state, sense a fifth characteristic voltage from a fifth channel line connected to a fifth pixel through the second sensing line while a fifth channel switch is in a turn-on state, and sense a sixth characteristic voltage from a sixth channel line connected to a sixth pixel through the second sensing line while a sixth channel switch is in a turn-on state. The first channel switch and the fifth channel switch are configured to be simultaneously turned on and off, and the second channel switch and the sixth channel switch are configured to be simultaneously turned on and off.

Example embodiments are not necessarily mutually exclusive. For example, some example embodiments may include one or more features described with reference to one or more figures, and may also include one or more other features described with reference to one or more other figures.

As described herein, any devices, systems, modules, portions, units, controllers, circuits, and/or portions thereof according to any of the example embodiments, and/or any portions thereof (including, without limitation, the host 200, the data driving circuit 120, the gate driving circuit 130, the timing controller 110, the driving circuit 121, the sensing circuit 122, any portion thereof, or the like) may include, may be included in, and/or may be implemented by one or more instances of processing circuitry such as hardware including logic circuits; a hardware/software combination such as a processor executing software; or a combination thereof. For example, the processing circuitry more specifically may include, but is not limited to, a central processing unit (CPU), an arithmetic logic unit (ALU), a graphics processing unit (GPU), an application processor (AP), a digital signal processor (DSP), a microcomputer, a field programmable gate array (FPGA), and programmable logic unit, a microprocessor, application-specific integrated circuit (ASIC), a neural network processing unit (NPU), an Electronic Control Unit (ECU), an Image Signal Processor (ISP), and the like. In some example embodiments, the processing circuitry may include a non-transitory computer readable storage device (e.g., a memory), for example a solid state drive (SSD), storing a program of instructions, and a processor (e.g., CPU) configured to execute the program of instructions to implement the functionality and/or methods performed by some or all of any devices, systems, modules, portions, units, controllers, circuits, and/or portions thereof according to any of the example embodiments.

Any of the elements and/or functional blocks disclosed above may include or be implemented in processing circuitry such as hardware including logic circuits; a hardware/software combination such as a processor executing software; or a combination thereof. For example, the processing circuitry more specifically may include, but is not limited to, a central processing unit (CPU), an arithmetic logic unit (ALU), a digital signal processor, a microcomputer, a field programmable gate array (FPGA), a System-on-Chip (SoC), a programmable logic unit, a microprocessor, application-specific integrated circuit (ASIC), etc. The processing circuitry may include electrical components such as at least one of transistors, resistors, capacitors, etc. The processing circuitry may include electrical components such as logic gates including at least one of AND gates, OR gates, NAND gates, NOT gates, etc.

According to some embodiments, wherein the first pixel includes a light emitting element and a driving transistor connected to the light emitting element and configured to drive the light emitting element, and the first channel switch is configured to turn on in response to the driving transistor moving to a cut-off region.

According to some embodiments, the method further comprising turning on a second reset switch of the first AFE circuit before a sampling switch of the first AFE circuit is turned on to provide a second compensation voltage to the first AFE circuit.

According to some embodiments, wherein the first reset switch is configured to turn on before the first channel switch is turned on.

According to some embodiments, wherein time periods during which the first channel switch in turn-on state and the second channel switch in turn-on state are the same.

While several embodiments have been provided in the present disclosure, it should be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

What is claimed is:

1. A data driving circuit comprising:
a first analog front-end (AFE) circuit configured to sense a first characteristic voltage from a first channel line connected to a first pixel through a first sensing line while a first channel switch is in a turn-on state, and configured to sense a second characteristic voltage from a second channel line connected to a second pixel through the first sensing line while a second channel switch is in a turn-on state; and
an analog-to-digital converter configured to convert an output signal received from the first AFE circuit into a digital compensation signal,
wherein the first AFE circuit includes,
a sampling capacitor configured to store at least a portion of a sensed characteristic voltage,
a sampling switch configured to selectively provide the sensed characteristic voltage to the sampling capacitor, and
a first reset switch having a first end connected to the first sensing line and a second end configured to receive a first compensation voltage, and the first reset switch configured to operate in accordance with a first reset signal,
wherein the first reset switch is configured to selectively provide the first compensation voltage to the first sensing line in response to the first reset signal turning on the first reset switch,
the first reset switch is configured to turn on before the second channel switch is turned on, and
the second channel switch is configured to turn on after the first channel switch is turned off.

2. The data driving circuit of claim 1, wherein the first reset switch is configured to operate in accordance with the first reset signal or a second reset signal, and the first reset switch is configured to selectively provide the first compensation voltage to the first sensing line in response to the second reset signal turning on the first reset switch, the first reset switch being turned on before the second channel switch is turned on.

3. The data driving circuit of claim 2, wherein the first reset switch is configured to selectively provide the first compensation voltage to the first sensing line in response to the second reset signal turning on the first reset switch while the first channel switch is in a turn-on state or the second channel switch is in a turn-on state.

4. The data driving circuit of claim 2, wherein the first reset switch is configured to operate based on an OR operation between the first reset signal and the second reset signal.

5. The data driving circuit of claim 2, further comprising a second AFE circuit adjacent to the first AFE circuit, wherein the second AFE circuit is configured to,
sense a third characteristic voltage from a third channel line connected to a third pixel through a second sensing line while a third channel switch is in a turn-on state,
sense a fourth characteristic voltage from a fourth channel line connected to a fourth pixel through the second sensing line while a fourth channel switch is in a turn-on state,
sense a fifth characteristic voltage from a fifth channel line connected to a fifth pixel through the second sensing line while a fifth channel switch is in a turn-on state, and
sense a sixth characteristic voltage from a sixth channel line connected to a sixth pixel through the second sensing line while a sixth channel switch is in a turn-on state,
wherein the first channel switch and the fifth channel switch are configured to simultaneously turn on and off, and
the second channel switch and the sixth channel switch are configured to simultaneously turn on and off.

6. The data driving circuit of claim 5, wherein two channel lines are connected to the first AFE circuit, the two channel lines including the first channel line and the second channel line, and
four channel lines are connected to the second AFE circuit.

7. The data driving circuit of claim 5, wherein the first AFE circuit is in a disable state, and the second AFE circuit is in an enable state.

8. The data driving circuit of claim 1, wherein a voltage level of the first compensation voltage is same as a voltage level of the first characteristic voltage.

9. The data driving circuit of claim 1, wherein the first pixel includes a light emitting element and a driving transistor connected to the light emitting element and configured to drive the light emitting element, and
the first channel switch is configured to turn on in response to the driving transistor moving to a cut-off region.

10. The data driving circuit of claim 1, wherein the first AFE circuit further includes a second reset switch having a first end connected to a node connecting the sampling capacitor with the sampling switch and a second end configured to receive a second compensation voltage, and
the second reset switch is configured to turn on before the sampling switch is turned on to selectively provide the second compensation voltage to the node.

11. The data driving circuit of claim 10, wherein a voltage level of the second compensation voltage is same as a voltage level of the first compensation voltage.

12. The data driving circuit of claim 1, further comprising a differential amplifier configured to receive a first output signal from the first AFE circuit, amplify the first output signal, generate a second output signal based on the amplified first output signal, and provide the second output signal to the analog-to-digital converter.

13. The data driving circuit of claim 1, wherein the first reset switch is configured to turn on before the first channel switch is turned on.

14. The data driving circuit of claim 13, wherein time periods during which the first channel switch in turn-on state and the second channel switch in turn-on state are same.

15. A method for operating a data driving circuit including a first analog front-end (AFE) circuit, the method comprising:
sensing a first characteristic voltage from a first channel line connected to a first pixel through a first sensing line while a first channel switch is in a turn-on state;
turning on a first reset switch in response to a first reset signal to provide a first compensation voltage to the first sensing line, the first reset switch being turned on before a second channel switch is turned on, and the second channel switch being turned on after the first channel switch is turned off; and
sensing a second characteristic voltage from a second channel line connected to a second pixel through the first sensing line while the second channel switch is in a turn-on state.

16. The method of claim 15, further comprising turning on the first reset switch in response to a second reset signal to provide the first compensation voltage to the first sensing line, the first reset switch being turned on before the second channel switch is turned off.

17. The method of claim 16, wherein the turning on the first reset switch in response to the second reset signal to provide the first compensation voltage to the first sensing line includes turning on the first reset switch in response to the second reset signal to provide the first compensation voltage to the first sensing line while the first channel switch is in a turn-on state or the second channel switch is in a turn-on state.

18. The method of claim 15, further comprising:
turning on the first reset switch in response to the first reset signal before a third channel switch is turned on to provide the first compensation voltage to the first sensing line, the third channel switch being turned on after the second channel switch is turned off;
sensing a third characteristic voltage from a third channel line connected to a third pixel through the first sensing line while the third channel switch is in a turn-on state;
turning on the first reset switch in response to the first reset signal before a fourth channel switch is turned on to provide the first compensation voltage to the first sensing line, the fourth channel switch being turned on after the third channel switch is turned off; and
sensing a fourth characteristic voltage from a fourth channel line connected to a fourth pixel through the first sensing line while the fourth channel switch is in a turn-on state.

19. The method of claim 15, wherein a voltage level of the first compensation voltage is same as a voltage level of the first characteristic voltage.

20. A data driving circuit comprising:
a first analog front-end (AFE) circuit configured to sense a characteristic voltage of a plurality of pixels through a sensing line and output an output signal; and
an analog-to-digital converter configured to receive the output signal, perform analog-digital conversion on the output signal, and output a digital compensation signal based on the analog-digital conversion performed on the output signal,
wherein the first AFE circuit includes,
a sampling capacitor configured to store at least a portion of a sensed characteristic voltage,
a sampling switch connected between the sensing line and the sampling capacitor, and configured to selectively provide the sensed characteristic voltage to the sampling capacitor,
a first reset switch having a first end connected to the sensing line and a second end configured to receive a first compensation voltage,
a second reset switch having a first end connected to a node connecting the sensing line with the sampling capacitor and a second end configured to receive a second compensation voltage, and
an output switch configured to selectively connect the sampling capacitor to the analog-to-digital converter and selectively provide the output signal to the analog-to-digital converter.
